(19) United States
(12) Patent Application Publication
(10) Pub. No.: US 2004/0218087 A1
(43) Pub. Date: Nov. 4, 2004

(54) Shutter delay calibration method and apparatus

(76) Inventors: Thomas Jazbutis, Fort Collins, CO (US); David Kay Campbell, Loveland, CO (US); Gregory V. Hofer, Loveland, CO (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/426,208

(22) Filed: Apr. 29, 2003

(51) Int. Cl. H04N 9/093; H04N 5/235

(52) U.S. Cl. 348/362; 348/263

(57) ABSTRACT

A lens/shutter/sensor assembly or complete camera makes a photographic exposure, targeting a target exposure time, of a stable light source. The exposure time is initiated electronically and terminated using an electromechanical shutter. A nominal value for the shutter delay is assumed. The exposure level of this first exposure is recorded. A second photographic exposure is made in the same way of the same light source, but targeting a different target exposure time. The exposure levels of the two photographic exposures, the target exposure times, and the assumed value of the shutter delay are used to compute the actual shutter delay. The actual shutter delay may optionally be associated with the shutter.

### FIELD OF THE INVENTION

The present invention relates generally to digital photography, and more specifically to the calibration, or measurement, of shutter delay.

### BACKGROUND OF THE INVENTION

A typical digital camera is based on an electronic array light sensor. For example, the sensor may be a charge coupled device (CCD) sensor in which light-sensitive “pixels” convert incident light into electrical charge that is stored in an array of charge coupled devices. Typically, a lens projects an image of a scene onto the surface of the sensor, so that sensor locations are mapped to scene locations and the array of accumulated charges represent a photograph of the scene.

In a typical picture-taking sequence, any stored charges are discarded, or “flushed” from the electronic array light sensor in a reset operation; the sensor is exposed to light from the scene for a time, allowing charge to be accumulate; and the accumulated charges are read out of the electronic array light sensor and converted into digital numbers that represent the scene. The resulting array of digital numbers may be called a digital photograph, a digital image, an image file, or simply a photograph.

The time period during which scene light is projected onto the sensor and charge is allowed to accumulate is called the exposure time. The photographer may select an exposure time, or the camera my select it automatically, so that the level of exposure of the photograph falls within the dynamic range of the camera. It is desirable that the camera expose a photograph for the specified time so that predictable and correct photographic results are obtained.

The exposure time may be controlled electronically, or by an electromechanical shutter, or by a combination of these. FIGS. 1A and 1B depict a camera lens 101 with an integral shutter 102. A typical camera lens may comprise several elements. In FIG. 1A, the shutter 102 is open and light from the scene is collected by the lens 101 and projected onto electronic array light sensor 103. In FIG. 1B, the shutter 102 is closed, and no light from the scene reaches electronic array light sensor 103.

To prevent additional exposure during the relative long readout time for a full resolution image, it is often advantageous to control the exposure time of a photograph by a combination of electronic and electromechanical means. A typical sequence, illustrated in FIG. 2, may be: 1) open the electromechanical shutter 102 (if the shutter is not already open from a previous operation), 2) reset the electronic array light sensor 103, thus beginning the exposure time, 3) allow charge to accumulate for a time, 4) send a signal to the electromechanical shutter 102 indicating that it should close, 5) after a “shutter delay” caused by various electrical and mechanical phenomena, the shutter 102 closes, thus ending the exposure time. Once the exposure time is ended, the camera may read the resulting image from the electronic array light sensor 103.

The shutter delay may be caused by the response time of electrical circuits, mechanical friction, inertia, or other factors. Typically, the delay may range from 1 to 3 milliseconds—a significant amount of variation in relation to the short exposure times that are desirable for the camera to provide. The camera may compensate for the shutter delay by sending the command to close the shutter 102 before the exposure of the photograph is to be terminated. In order for the resulting exposure time to be accurate, an estimate of the shutter delay is needed.

Due to manufacturing variations, the shutter delay may vary from one particular shutter to another. Therefore each shutter may be characterized, and the delay information communicated to the camera so that the camera can use the delay information in compensating for shutter delay during the taking of photographs. It is not sufficient to characterize a shutter model and use the same delay time for each shutter of that model. Each shutter is characterized.

One method for measuring shutter delay is to mount the shutter in a fixture that shines light through the shutter and onto a photodetector. A drive circuit drives the shutter, and an instrument such as an oscilloscope records the output of the photodetector. An operator reads the shutter delay by interpreting the oscilloscope output. However, this method is labor intensive, does not account for any variations in camera electronics, and it requires a system for associating a shutter and its delay data for transfer to a camera.

U.S. patent application Ser. No. 09/603,133, filed Jun. 23, 2000 and having a common assignee with the present application, discloses another method of measuring shutter delay. In this method, a camera takes exposures of a light source using both all-electronic shuttering and combined electronic and electromechanical shuttering. The shutter delay is adjusted until the two methods agree.

However, differences between the all electronic shuttering and combined electronic and electromechanical shuttering can lead to shutter delay measurement error. An improved method of measuring shutter delay is needed.

### SUMMARY OF THE INVENTION

A lens/shutter/sensor assembly or complete camera makes a photographic exposure, targeting a target exposure time, of a stable light source. The exposure time is initiated electronically and terminated using an electromechanical shutter. A nominal value for the shutter delay is assumed. The exposure level of this first exposure is recorded. A second photographic exposure is made in the same way of the same light source, but targeting a different target exposure time. The exposure levels of the two photographic exposures, the target exposure times, and the assumed value of the shutter delay are used to compute the actual shutter delay. The actual shutter delay may optionally be associated with the shutter.

### BRIEF DESCRIPTION OF THE DRAWINGS

FIG. 1A depicts a camera lens, shutter, and sensor, with the shutter in the open position.

FIG. 1B depicts the camera lens, shutter, and sensor of FIG. 1A with the shutter in the closed position.

FIG. 2 shows a timing diagram of a typical photographic sequence.

FIG. 3 shows a calibration system that can calibrate shutter delay in accordance with an example embodiment of the invention.

FIG. 4 depicts a flow chart of a method in accordance with an example embodiment of the invention.

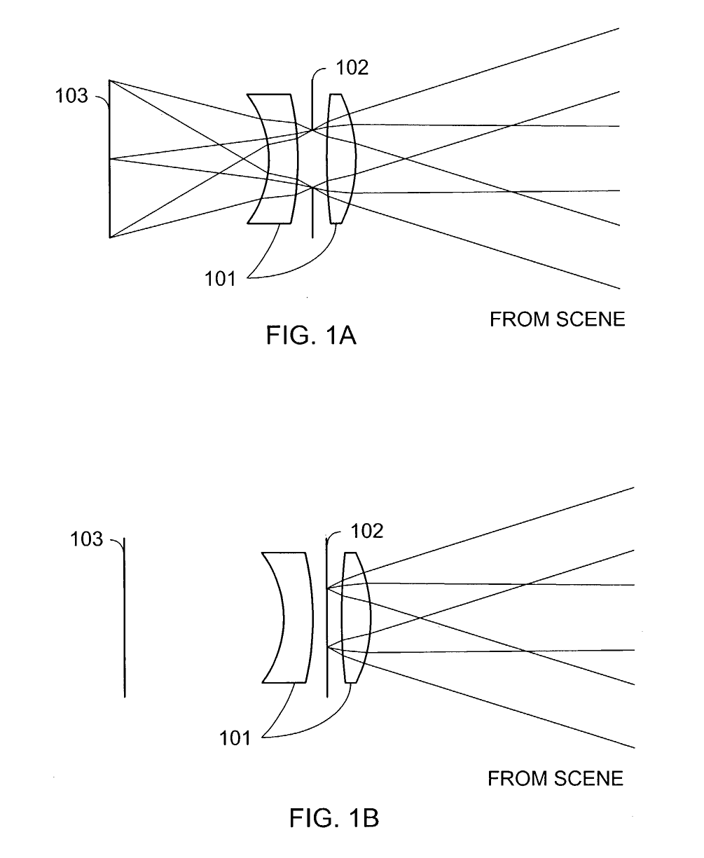

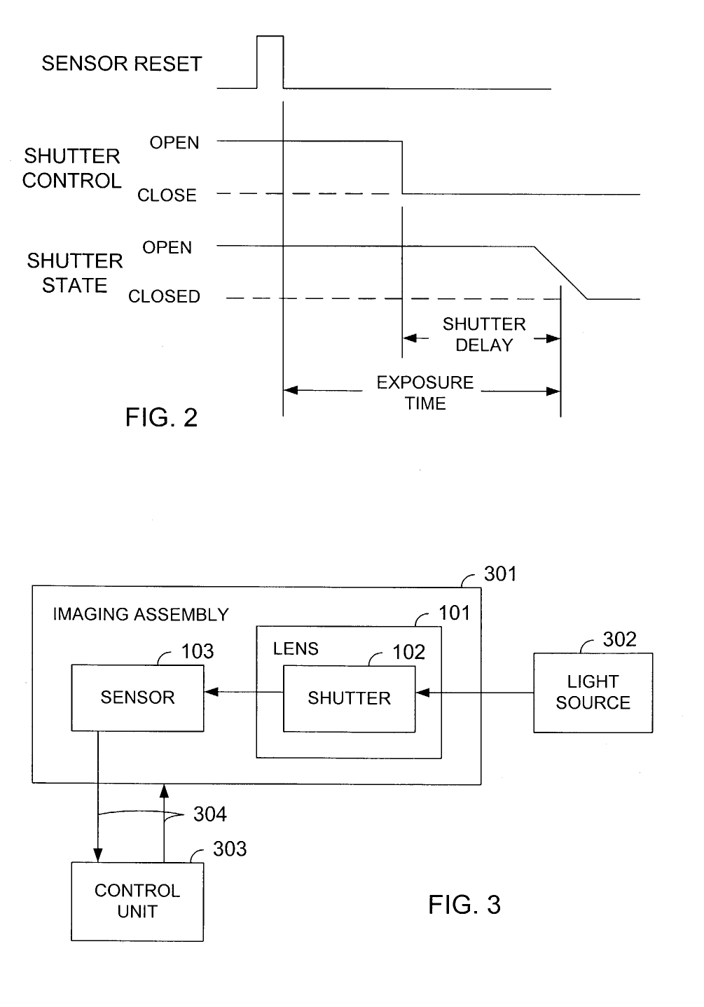

### DETAILED DESCRIPTION OF THE PREFERRED EMBODIMENT

FIG. 3 shows a calibration system that can calibrate shutter delay in accordance with an example embodiment of the invention. Imaging assembly 301 comprises a lens 101, of which electromechanical shutter 102 may be a part, and electronic array light sensor 103. Light source 302 supplies light of substantially stable brightness. For example, a calibrated light source such as a Kyoritsu LB-5000 Light Box may be used. Electronic control unit 303 controls the operation of imaging assembly 301, including signaling actuation of electromechanical shutter 102, controlling electronic array light sensor 103, and reading image data from electronic array light sensor 103.

The imaging assembly 301 may be in a completed camera, or may be a subsystem that will be assembled into a camera at a later time. Imaging assembly 301 is sufficiently operable to take controlled photographic exposures of the light source, while under the control of control unit 303. Control unit 303 may be the electronic control portion of a camera or part of a dedicated calibration system, and may include a computer. The electronic control portion of a digital camera may typically include a microprocessor and/or digital signal processor, timing generation circuitry, data storage, user control inputs, and such. For the purposes of this application, the electronic control portion of a digital camera does not include the electronic array light sensor.

In the case where control unit 303 includes a computer, control unit 303 may exchange data and commands with imaging assembly 301 over an appropriate interface 304. Interface 304 may be, for example, a USB interface, or some other standard interface, or an interface designed specifically for this application.

The light source 302 is preferably sufficiently bright that a relatively short exposure time will suffice to create a digital image that uses a substantial portion of the dynamic range of the imaging assembly. For example, the light source may be selected such that an exposure time of 15 milliseconds will be sufficient to saturate the charge-accumulation capacity of electronic array light sensor 103. Preferably, the intensity of the light source is stable enough that the intensity does not change substantially in a time interval of 5 to 10 seconds.

During a calibration in accordance with an example embodiment of the invention, an estimate of the shutter delay is assumed, and a first photographic exposure is taken by exposing the imaging assembly to the light source 302 with a predetermined target exposure time. The exposure time is initiated electronically, and terminated with the electromechanical shutter 102. For example, the assumed shutter delay may be 2 milliseconds, and the target exposure time may be 5 milliseconds. In this example case, control unit 303 may control imaging assembly 301 to 1) ensure that the electromechanical shutter 102 is open, 2) reset electronic array light sensor 103, starting the exposure time, 3) after a delay of 3 milliseconds (the target exposure time of 5 milliseconds less the assumed shutter delay of 2 milliseconds), signal the electromechanical shutter 102 to close, and 4) after the shutter 102 has closed, read the digital image from electronic array light sensor 103.

The process of signaling the electromechanical shutter 102 to close after an interval that is the target exposure time less the assumed shutter delay may be termed “targeting” an exposure time equal to the target exposure time.

The exposure level of the resulting digital image is then evaluated and retained. Any of a number of methods for evaluating the exposure level of the digital image may be used. For example, the control unit 303 may be the electronic control portion of a camera that has dedicated hardware for constructing histograms of digital images. A histogram is a list of the numbers of image pixels falling into equally spaced brightness bins. The control unit 303 may measure the exposure level as the median value in a histogram of the digital image. Alternatively, the control unit 303 may simply sum or average the numerical values of all the pixels in the digital image, or the control unit 303 may sum or average the numerical values of a subset of the pixels in the digital image. Similarly, the control unit 303 may compute a histogram and the median value of the histogram using a program executing on a processor, without the use of dedicated hardware that computes histograms. Other methods of evaluating the exposure level of the digital image may be used.

Optionally, more than one exposure may be taken with the same target exposure time, and the exposure levels of the resulting multiple digital images averaged to further refine the exposure level determination for a particular target exposure time. This averaging helps reduce the effect of electronic noise in the digital images, or other phenomena that may compromise the accuracy of the exposure level determination.

After the first photographic exposure, a second photographic exposure is taken of the light source 302, using the same assumed value for the shutter delay, but targeting a different exposure time. (Note that the order of the first and second photographic exposures may be reversed.) For example, in the second photographic exposure, the shutter delay may be assumed to be 2 milliseconds, but the target exposure time may be 10 milliseconds. Thus, in taking the second photographic exposure, control unit 303 may control imaging assembly 301 to 1) ensure that the electromechanical shutter 102 is open, 2) reset electronic array light sensor 103, starting the exposure time, 3) after a delay of 8 milliseconds (the target exposure time of 10 milliseconds less the assumed shutter delay of 2 milliseconds), signal the electromechanical shutter 102 to close, and 4) after the shutter 102 has closed, read the digital image from electronic array light sensor 103. The exposure level of the second photographic exposure is then evaluated and recorded, using the same method as was used to evaluate the exposure of the first photographic exposure.

The response of imaging assembly 301 and control unit 303 is generally linear. That is, the numerical values in a digital image taken with the system will be directly proportional to the amount of light collected by the system. Because light source 302 is substantially stable, and no other parameters were changed between the first and second photographic exposures, the exposure levels of the two photographic exposures are substantially in proportion to the exposure times of the two photographic exposures.

For example, if the shutter delay of shutter 102 is in fact the assumed value of 2 milliseconds, then the exposure time of the first example photographic exposure is in fact the target exposure time of 5 milliseconds, and the exposure time of the second example photographic exposure was in fact the target exposure time of 10 milliseconds. Designating the exposure levels of the first and second exposures as EL₁ and EL₂ respectively, the target exposure times of the two exposures as T_{targ1} and T_{targ2}, and the exposure times of the two exposures as T_{act1} and T_{act2} respectively:

T_{targ1}=T_{act1}=5 milliseconds

T_{targ2}=T_{act2}=10 milliseconds

$$\frac{{EL}_{2}}{{EL}_{1}} = \frac{{T}_{targ2}}{{T}_{targ1}} = \frac{{T}_{act2}}{{T}_{act1}} = \frac{10}{5} = 2.0 ( Shutter delay = 2 ms )$$

However, if the shutter delay is different than the assumed value of 2.0 milliseconds, then these mathematical relationships will not all hold, because the actual exposure times will not equal the target exposure times. For example, if the shutter delay is actually only 1 millisecond, rather than the assumed 2 milliseconds, then the first and second actual exposure times will be only 4 and 9 milliseconds respectively. Accordingly:

$$\frac{{EL}_{2}}{{EL}_{1}} = \frac{{T}_{act2}}{{T}_{act1}} = \frac{9}{4} = 2.25 \neq \frac{{T}_{targ2}}{{T}_{targ1}} ( Shutter delay = 1 ms )$$

This effect, whereby the ratio of the exposure levels differs from the ratio of the target exposure times when the shutter delay differs from its assumed value, may be used to calculate the shutter delay. Designating the error in the assumed shutter delay as E, then:

T_{act1}=T_{targ1}-E

T_{act2}=T_{targ2}-E

and,

$$\frac{{EL}_{2}}{{EL}_{1}} = \frac{{T}_{act2}}{{T}_{act1}} = \frac{{T}_{targ2} - E}{{T}_{targ1} - E}$$

Solving for E gives

$$E = \frac{{T}_{targ1} - \frac{{EL}_{1}}{{EL}_{2}} {T}_{targ2}}{1 - \frac{{EL}_{1}}{{EL}_{2}}}$$

In the above example wherein EL₁/EL₂=4/9, T_{targ2}=10, T_{targ1}=5, we find that E=1. That is, the assumed shutter delay was longer than the actual shutter delay by 1 millisecond.

Similarly, for a case where the target exposure time for the first photographic exposure is 5 milliseconds (T_{targ1}=5), the target exposure time for the second photographic exposure is 10 milliseconds (T_{targ2}=10), the assumed shutter delay is 2 milliseconds, and the resulting measurements of the exposure levels of the two exposures reveals that EL₂/EL₁=1.90, we find that E=−0.55. That is, the assumed shutter delay was shorter than the actual delay by 0.55 milliseconds, so the actual shutter delay is 2.55 milliseconds.

The computation of the shutter delay may be performed in the control unit 303, for example using a microprocessor or digital signal processor. Control unit 303 may be the electronic control portion of a completed camera, the electronic control portion of a camera and a computer in communication, or part of a calibration fixture, which may also include a computer.

Optionally, the shutter delay calibration may be iterative. For example, once the shutter delay has been computed as described above, the calibration sequence may be repeated one or more times, each repetition using the most recently computed shutter delay estimate as the assumed shutter delay. Each iteration may further refine the shutter delay calibration. Typically, two to three iterations may be used.

Once the actual shutter delay has been found, the shutter delay value may be associated with the particular shutter that was measured. For example, the shutter delay value may be stored in a non-volatile memory in the electronic control portion of the camera in which the shutter is mounted. A non-volatile memory may be a Programmable Read-Only Memory (PROM), and Eraseable Programmable Read-Only Memory (EPROM), and Electrically Eraseable Programmable Read-Only Memory (EEPROM), a flash memory, or some other kind of non-volatile storage. The camera can then use the measured actual shutter delay to take photographs with accurate exposure times.

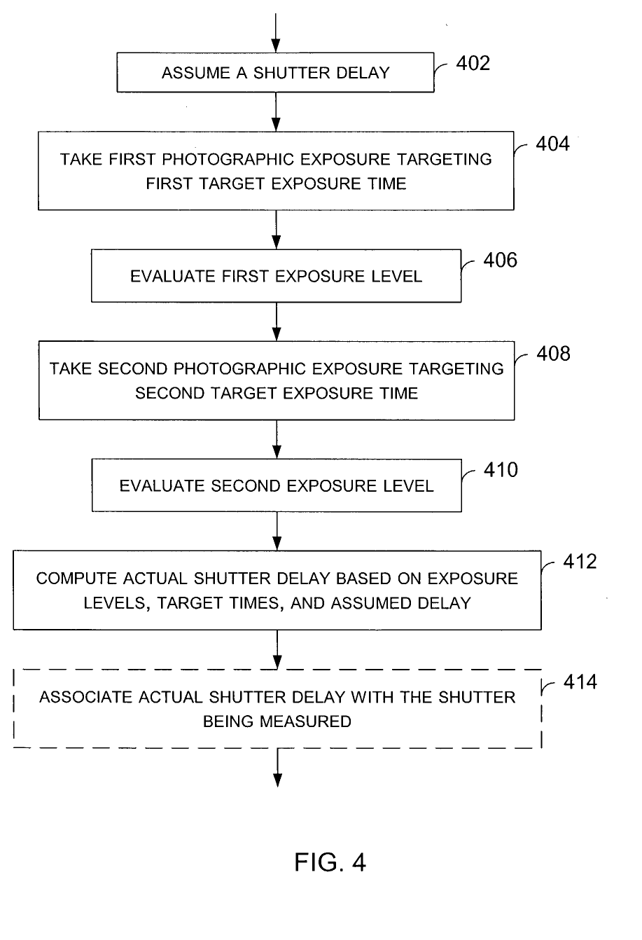

FIG. 4 depicts a flow chart of a method in accordance with an example embodiment of the invention. At step 402, a shutter delay time is assumed. At step 404, a first photographic exposure is taken targeting a first target exposure time. At step 406, the exposure level of the first photographic exposure is evaluated. At step 408, a second photographic exposure is taken, targeting a second target exposure time different from the first target exposure time. At step 410, the exposure level of the second photographic exposure is evaluated. At step 412, the actual shutter delay is computed using the exposure levels, target exposure times, and the assumed shutter delay. At optional step 414, the calculated actual shutter delay may be associated with the shutter that was measured.

The foregoing description of the present invention has been presented for purposes of illustration and description. It is not intended to be exhaustive or to limit the invention to the precise form disclosed, and other modifications and variations may be possible in light of the above teachings. For example, the electronic array light sensor used in the shutter calibration may be an active-pixel complementary metal oxide semiconductor (CMOS) sensor rather than a charge coupled device sensor. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of measuring shutter delay, comprising the steps of:
a) assuming a shutter delay time for a shutter;
b) taking a first photographic exposure targeting a first target exposure time;
c) evaluating a first exposure level of the first photographic exposure;
d) taking a second photographic exposure targeting a second target exposure time;
e) evaluating a second exposure level of the second photographic exposure; and
f) computing an actual shutter delay based on the first and second target exposure times, the first and second exposure levels, and the assumed shutter delay.

2. The method of claim 1 further comprising the step of associating the actual shutter delay with the shutter.

3. The method of claim 1 wherein the first and second photographic exposures are taken of a substantially stable light source.

4. The method of claim 1 wherein the second target exposure time is longer than the first target exposure time.

5. The method of claim 1 wherein the shutter is electromechanical, and each photographic exposure is initiated by electronic means and terminated by the electromechanical shutter.

6. The method of claim 5 wherein each photographic exposure is initiated by resetting an electronic array light sensor while the electromechanical shutter is open.

7. The method of claim 1 performed with the shutter included in a completed camera.

8. The method of claim 1 performed with the shutter being part of an imaging assembly that comprises less than a completed camera.

9. The method of claim 1 wherein the computing step is performed by the electronic control portion of a digital camera.

10. The method of claim 1 wherein the computing step is performed by a computer.

11. The method of claim 1 wherein evaluating the exposure level of a photographic exposure comprises finding the median value of a histogram of a digital image.

12. The method of claim 1 wherein evaluating the exposure level of a photographic exposure comprises finding a sum of the numerical values in a digital image.

13. The method of claim 1 wherein evaluating the exposure level of a photographic exposure comprises finding an average of the numerical values in a digital image.

14. The method of claim 1 wherein evaluating the exposure level of a photographic exposure is uses a subset of the pixels in a digital image.

15. The method of claim 1, further comprising:
a) repeating the step of taking a first photographic exposure targeting a first target exposure time and the step of evaluating a first exposure level of the first photographic exposure; and
b) averaging the exposure levels from the resulting multiple digital images.

16. The method of claim 1, further comprising:
a) repeating the step of taking a second photographic exposure targeting a second target exposure time and the step of evaluating a second exposure level of the second photographic exposure; and
b) averaging the exposure levels from the resulting multiple digital images.

17. The method of claim 1, further comprising:
a) replacing the assumed delay time with the computed actual shutter delay time; and
b) repeating steps b) through f) of the method of claim 1.

18. A system, comprising:
a) an imaging assembly comprising an electromechanical shutter and an electronic array light sensor;
b) a control unit; and
c) a substantially stable light source;
the system configured to perform a method comprising the steps of:
i. assuming a shutter delay time;
ii. taking first and second photographic exposures of the substantially stable light source, targeting first and second target exposure times respectively;
iii. evaluating first and second exposure levels of the first and second photographic exposures respectively; and
iv. computing an actual shutter delay from the first and second target exposure times, the first and second exposure levels, and the assumed shutter delay.

19. The system of claim 18 further comprising a lens.

20. The system of claim 19 wherein the electromechanical shutter is integrated into the lens.

21. The system of claim 18 wherein the control unit is the electronic control portion of a digital camera.

22. The system of claim 18 wherein the control unit includes a computer.

23. The system of claim 18 wherein the electronic array light sensor is a charge coupled device sensor.

24. A system of claim 18 wherein the electronic array light sensor is an active pixel CMOS sensor.

25. A system, comprising:
a) means for providing light;
b) means for taking digital images of the means for providing light;
c) means for evaluating the exposure levels of the digital images; and
d) means for computing a shutter delay based on the exposure levels of the digital images, and assumed shutter delay, and target exposure times of the digital images.
